(19) United States
(12) Patent Application Publication
(10) Pub. No.: US 2025/0305884 A1
(43) Pub. Date: Oct. 2, 2025

(54) ELECTROMAGNETIC WAVE SENSOR

(71) Applicant: TDK CORPORATION, Tokyo (JP)

(72) Inventors: Susumu AOKI, Tokyo (JP); Eiji KOMURA, Tokyo (JP); Shinji HARA, Tokyo (JP); Naoki OHTA, Tokyo (JP); Takahiro NAKAGAWA, Tokyo (JP)

(73) Assignee: TDK CORPORATION, Tokyo (JP)

(21) Appl. No.: 19/045,759

(22) Filed: Feb. 5, 2025

(30) Foreign Application Priority Data
Mar. 26, 2024 (JP) 2024-049541

(51) Int. Cl. G01J 5/04; G01J 5/06; G01J 5/20

(52) U.S. Cl. CPC G01J 5/04; G01J 5/06; G01J 2005/202

(57) ABSTRACT

An electromagnetic wave sensor has a first substrate; a second substrate that faces the first substrate, that forms an inner space between the first substrate and the second substrate, and that transmits electromagnetic waves; and electromagnetic wave detection elements that are provided in the inner space. The second substrate has an inner surface that faces the first substrate. The inner surface has element facing regions that face the electromagnetic wave detection elements. The element facing regions include a protrusion-recess structure. The protrusion-recess structure has protrusion-recess elements that are formed of recesses or protrusions. As seen in a direction in which the first substrate and the second substrate face each other, a distance between a center of a protrusion-recess element and a center of another protrusion-recess element that is closest to the protrusion-recess element is less than 8 μm.

### TECHNICAL FIELD

The present application is based on and claims priority from JP2024-49541 filed on Mar. 26, 2024, the disclosure of which is hereby incorporated by reference herein in its entirety.

The present disclosure relates to an electromagnetic wave sensor.

### DESCRIPTIONS OF THE RELATED ART

Sensors that detect electromagnetic waves such as infrared rays are known. WO2019/171488 discloses an electromagnetic wave sensor that has a first substrate, a second substrate that faces the first substrate, and electromagnetic wave detection elements that are arranged between the first substrate and the second substrate. The electromagnetic wave detection elements detect electromagnetic waves that pass through the second substrate.

### SUMMARY

In order to increase the sensitivity for detecting electromagnetic waves, it is desired to increase the intensity of electromagnetic waves that are inputted to the electromagnetic wave detection element, and to do so, it is desired to increase the transmission rate of electromagnetic waves of the second substrate.

An electromagnetic wave sensor has a first substrate; a second substrate that faces the first substrate and that forms an inner space between the first substrate and the second substrate, and that transmits electromagnetic waves; and electromagnetic wave detection elements that are provided in the inner space. The second substrate has an inner surface that faces the first substrate. The inner surface has element facing regions that face the electromagnetic wave detection elements. The element facing regions include a protrusion-recess structure. The protrusion-recess structure has protrusion-recess elements that are formed of recesses or protrusions. As seen in a direction in which the first substrate and the second substrate face each other, a distance between a center of a protrusion-recess element and a center of another protrusion-recess element that is closest to the protrusion-recess element is less than 8 μm.

### BRIEF DESCRIPTION OF THE DRAWINGS

FIG. 1 is a schematic side view of an infrared sensor of a first embodiment;

FIG. 2 is a partial plan view of the infrared sensor that is shown in FIG. 1;

FIG. 3 is a partial enlarged sectional view of the second substrate of the infrared sensor that is shown in FIG. 1;

FIG. 4 is an enlarged view of part C in FIG. 3;

FIG. 5 is a schematic perspective view of the inner surface of the second substrate;

FIG. 6 is a schematic partial plan view of the inner surface of the second substrate;

FIGS. 7A and 7B are schematic views of a model that was used in a simulation;

FIGS. 8A and 8B are graphs that show the simulation results;

FIGS. 9A to 9H are sectional views that show the steps for forming a protrusion-recess structure;

FIGS. 10A to 10D are sectional views that show modifications of the protrusions;

FIG. 11 is a partial enlarged sectional view of the second substrate of a modification of the first embodiment;

FIG. 12 is a schematic perspective view of the inner surface of the second substrate that is shown in FIG. 11;

FIG. 13 is a schematic partial plan view of the inner surface of the second substrate that is shown in FIG. 11;

FIG. 14 is a partial enlarged sectional view of the second substrate of the infrared sensor of a second embodiment;

FIG. 15 is an enlarged view of part E in FIG. 14;

FIG. 16 is a schematic perspective view of the inner surface of the second substrate that is shown in FIG. 14;

FIG. 17 is a schematic partial plan view of the inner surface of the second substrate that is shown in FIG. 14;

FIGS. 18A and18B are schematic views of a model that was used in a simulation;

FIGS. 19A and19B are graphs that show the simulation results;

FIG. 20 is a partial enlarged sectional view of the second substrate of a modification of the second embodiment;

FIG. 21 is a schematic perspective view of the inner surface of the second substrate that is shown in FIG. 20; and

FIG. 22 is a schematic partial plan view of the inner surface of the second substrate that is shown in FIG. 20.

### DETAILED DESCRIPTION

Embodiments of the electromagnetic wave sensor of the present disclosure are next described with reference to the drawings. The drawings are schematic views that illustrate examples of the present disclosure, and the shapes and dimensions of elements may be inconsistent among the drawings. In the following descriptions and drawings, the X-direction and the Y-direction are parallel to main surface 2A of first substrate 2 and main surface 3A of second substrate 3. Main surfaces 2A and 3A are surfaces of first substrate 2 and a surface of second substrate 3 that face each other. The X-direction and the Y-direction are perpendicular to each other. The Z-direction is perpendicular both to the X-direction and the Y-direction and is orthogonal both to main surface 2A of first substrate 2 and main surface 3A of second substrate 3. The Z-direction is also the direction in which first substrate 2 and second substrate 3 face each other.

The following embodiments are directed to an infrared sensor as an example of the electromagnetic wave sensor. An infrared sensor is mainly used as an image sensor of an infrared camera. An infrared camera may be used in the dark for a night-vision scope or night-vision goggles and may also be used to measure the temperature of a human body or an object. The electromagnetic wave sensor of the present disclosure may be applied to an infrared sensor that detects infrared rays having wavelength of about 8 μm or larger, but waves to be detected are not limited to infrared rays. The present disclosure may be applied, for example, to an electromagnetic wave sensor that detects electromagnetic waves such as terahertz waves.

### First Embodiment

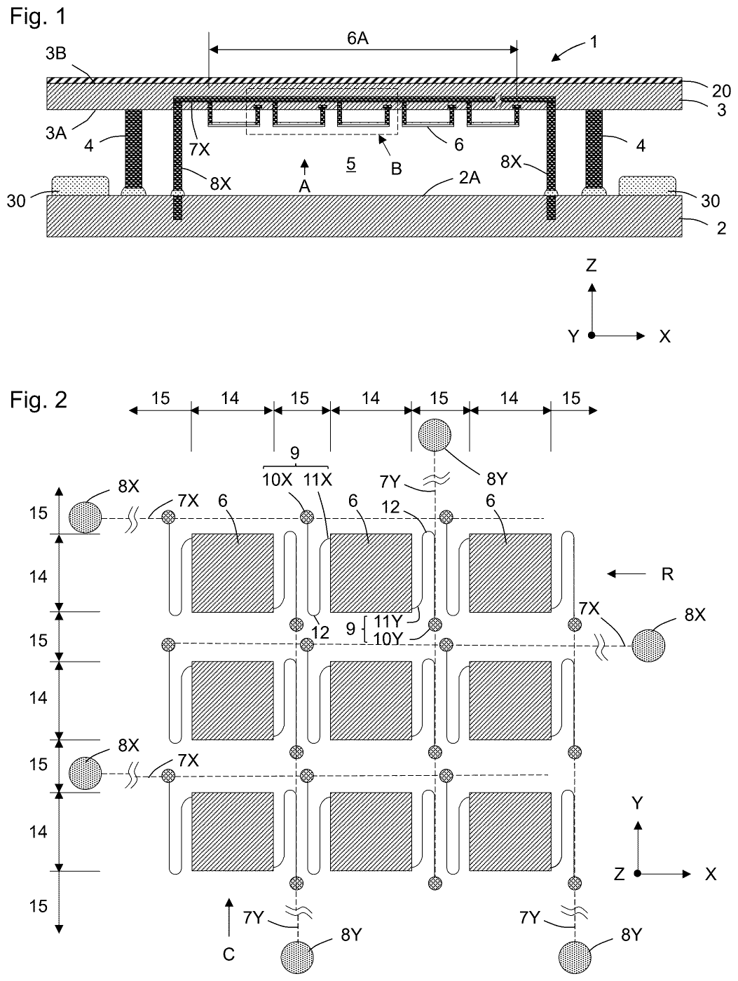

FIG. 1 is a schematic side view of infrared sensor 1. Infrared sensor 1 has first substrate 2 and second substrate 3 that are arranged to face each other. Infrared sensor 1 has side wall 4 that connects first substrate 2 and second substrate 3 and that extends in the circumferential direction. First substrate 2, second substrate 3, and side wall 4 form closed inner space 5. Electromagnetic wave detection elements 6 that function as sensing parts of infrared sensor 1 are provided in inner space 5. Inner space 5 is maintained at a negative pressure or as a vacuum. Thus, the convection of gas in inner space 5 is prevented or limited, and thermal influence on electromagnetic wave detection elements 6 can be mitigated.

First substrate 2 is mainly formed of a silicon substrate and includes electric circuits such as an ROIC (readout IC) and internal wiring (both not illustrated). The ROIC reads out output signals of electromagnetic wave detection elements 6. Pads 30 for inputting signals from the outside and for outputting signals to the outside are formed on first substrate 2 outside of side walls 4. Pads 30 are electrically connected to the ROIC by internal wiring. Second substrate 3 is also mainly formed of a silicon substrate and provides an input portion for infrared rays. Second substrate 3 transmits infrared rays and allows the incidence of the infrared rays on electromagnetic wave detection elements 6. First substrate 2 and second substrate 3 may alternatively be formed of germanium substrates that transmit infrared rays.

FIG. 2 is a partial plan view of infrared sensor 1 as seen in the A-direction in FIG. 1. Electromagnetic wave detection elements 6 form a lattice-shaped two-dimensional array that consists of rows R that extend in the X-direction and columns C that extend in the Y-direction. Electromagnetic wave detection elements 6 each include, for example, a thermistor film and a dielectric layer that covers at least a part of the thermistor film. The thermistor film may be formed of, for example, vanadium oxide, titanium oxide, amorphous silicon, polycrystalline silicon, an oxide of a spinel structure that includes manganese, or an oxide of yttrium-valium-copper. The dielectric layer that covers at least a part of the thermistor film may be formed of aluminum nitride, silicon nitride, aluminum oxide, silicon oxide, or the like and works as an absorber of electromagnetic waves.

Infrared sensor 1 has first wires 7X that extends in the X-direction, second wires 7Y that extends in the Y-direction, first electric connection members 8X, and second electric connection members 8Y. Each of first wires 7X is connected to a corresponding first electric connection member 8X, and each of second wires 7Y is connected to a corresponding second electric connection member 8Y. First wires 7X and second wires 7Y extend at different levels in the Z-direction. As shown in FIG. 1, first electric connection members 8X are cylindrical conductors that extend in the Z-direction between first substrate 2 and second substrate 3, and although not illustrated in FIG. 1, second electric connection members 8Y are also cylindrical conductors that extend in the Z-direction between first substrate 2 and second substrate 3. In the present embodiment, first electric connection members 8X are arranged on both sides of arrangement area 6A of electromagnetic wave detection elements 6 regarding the X-direction, but may also be arranged on one side of arrangement area 6A regarding the X-direction. First electric connection members 8X are arranged in a single column on each side of arrangement area 6A but may also be arranged in more than one column on each side of arrangement area 6A. The above arrangement may also apply to second electric connection members 8Y.

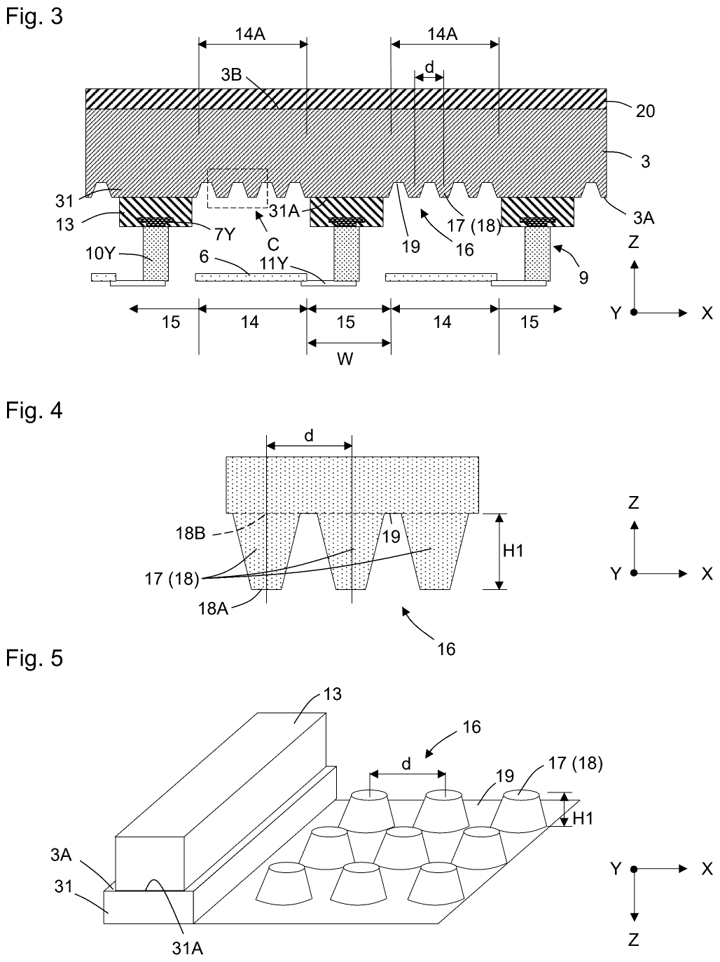

FIG. 3 is an enlarged view of part B in FIG. 1. Infrared sensor 1 has support portions 9. Each support portion 9 supports corresponding electromagnetic wave detection element 6. As shown in FIG. 2, each support portion 9 has first conductive pillar 10X that is connected to first wire 7X, first conductive arm 11X that is connected both to first conductive pillar 10X and electromagnetic wave detection element 6, second conductive pillar 10Y that is connected to second wire 7Y, and second conductive arm 11Y that is connected both to second conductive pillar 10Y and electromagnetic wave detection element 6. Each first wire 7X is connected to first conductive pillar 10X of one of the rows. Although not illustrated, each second wire 7Y is connected to second conductive pillar 10Y of one of the columns. Accordingly, each electromagnetic wave detection element 6 is connected to one of first wires 7X and one of second wires 7Y via first and second conductive pillars 10X and 10Y and first and second conductive arms 11X and 11Y.

When infrared sensor 1 operates, current sequentially flows in first electric connection member 8X, first wire 7X, first conductive pillar 10X, first conductive arm 11X, electromagnetic wave detection element 6 (the thermistor film), second conductive arm 11Y, second conductive pillar 10Y, second wire 7Y, and second electric connection member 8Y (or flows in the opposite direction). Each first conductive arm 11X includes bent portion 12 that increases the total length of first conductive arm11X, and each second conductive arm 11Y includes bent portion 12 that increases the total length of second conductive arm 11Y. Because electromagnetic wave detection elements 6 are arranged near second substrate 3 and the distance from first substrate 2 is larger than the distance from second substrate 3, influence on electromagnetic wave detection elements 6 from the heat that is generated in first substrate 2 can be mitigated.

As shown in FIG. 3, insulation film 13 is provided between second conductive pillars 10Y and second substrate 3. Second wires 7Y are supported by insulation film 13 and are electrically connected to second conductive pillars 10Y. Although not illustrated, insulation film 13 is also provided between first conductive pillars 10X and second substrate 3, and first wires 7X are supported by insulation film 13 and are electrically connected to first conductive pillars 10X.

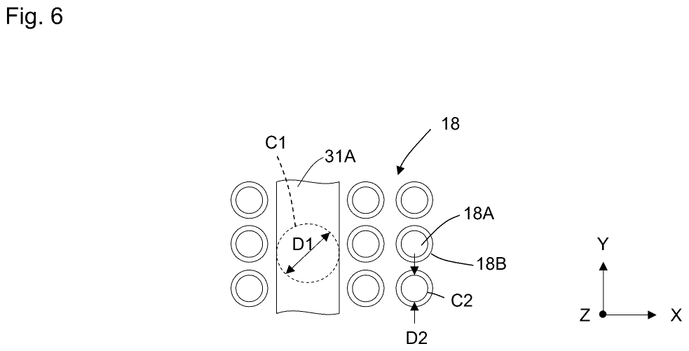

FIG. 4 is an enlarged view of part C in FIG. 3, and FIG. 5 is a schematic perspective view of inner surface 3A of second substrate 3. FIG. 5 is shown upside down in the Z-direction compared to FIGS. 1, 3, and 4. FIG. 6 is a schematic partial plan view of inner surface 3A of second substrate 3. Referring to FIGS. 1 to 6, the arrangement of second substrate 3 will next be described in more detail. As shown in FIGS. 1 and 3, second substrate 3 has inner surface 3A (the same as main surface 3A) that faces first substrate 2 and outer surface 3B that is the back surface of inner surface 3A. Both inner surface 3A and outer surface 3B are surfaces of a silicon substrate. Inner surface 3A has element facing regions 14 that face electromagnetic wave detection elements 6 in the Z-direction and boundary region 15 that is arranged between element facing regions 14 and that separates element facing regions 14. Although not illustrated, boundary region 15 is arranged in a lattice pattern. Element facing regions 14 are projections of electromagnetic wave detection elements 6, these projections being projected onto inner surface 3A in the Z-direction. Insulation film 13 and support portions 9 are supported by boundary region 15 of second substrate 3.

Element facing regions 14 have protrusion-recess structures 16 that are formed of silicon. Protrusion-recess structure 16 is formed of protrusion-recess elements 17 that have substantially the same shape and dimension. In the present embodiment, protrusion-recess elements 17 are protrusions 18. Each protrusion 18 is substantially a truncated cone in which the area of top portion 18A that faces first substrate 2 is smaller than the area of base portion 18B. Top portions 18A of protrusions 18 are positioned at the same level as inner surface 3A in the Z-direction. As seen in the Z-direction, protrusions 18 are substantially arranged in a lattice pattern, but alternatively may be arranged in a staggered pattern, may be partially arranged in a lattice pattern or a staggered pattern, or may be arranged in a totally random pattern. Flat regions 19 are provided on the sides of base portions 18B.

A portion of infrared rays that are incident to second substrate 3 is transmitted through second substrate 3, another portion of the infrared rays is reflected by outer surface 3B or inner surface 3A of second substrate 3, and the remaining portion is absorbed by second substrate 3. Because the percentage of infrared rays that are absorbed by second substrate 3 is very low, it is desired to limit the reflection of infrared rays on second substrate 3 in order to efficiently detect infrared rays. Generally, reflection occurs at boundaries between materials having different refraction indexes, and reflection increases when the difference between the refraction indexes of materials is large. Since the refraction index of a silicon substrate is 3.4 and the refraction index of a vacuum is 1.0, a large amount of reflection will occur due to the large difference between the refraction indexes if no measure is taken to limit reflection. However, infrared rays have the property of sensing the refraction index of a protrusion-recess structure that is smaller than the wavelength of the infrared rays as an average value of the refraction indexes of the two mediums that form the protrusion-recess structure (in this case, silicon and a vacuum). Due to this property, the large change in the refraction indexes at the boundary is limited and reflection is suppressed. In addition, when protrusions 18 are, for example, truncated cone as shown in FIG. 4, the ratio of the area of silicon and the area of vacuum in the X-Y section gradually changes in the Z-direction (in this case, the ratio of the area of vacuum increases with progression toward first substrate 2). Accordingly, the refraction index of protrusion-recess structure 16 continuously changes in the Z-direction and reflection is further suppressed.

Specifically, protrusion-recess structure 16 that is smaller than the wavelength of the infrared rays is a protrusion-recess structure in which, as seen in the Z-direction, the distance between the center of each protrusion-recess element 17 and the center of another protrusion-recess element 17 that is the closest to said each protrusion-recess element 17 is smaller than the wavelength of the infrared rays. Because infrared sensor 1 is usually used in the atmosphere, a portion of infrared rays that travel toward infrared sensor 1 is absorbed by elements in the atmosphere without being incident to infrared sensor 1. The wavelengths of infrared rays that are absorbed depend on elements in the atmosphere, but infrared rays having wavelengths in the range of 8-14 μm are less likely to be absorbed by the elements in the atmosphere. In the present embodiment, as seen in the Z-direction, the distance d between the center of each protrusion-recess element 17 (the center of top portion 18A of protrusion 18 or the center of base portion 18B of protrusion 18) and the center of another protrusion-recess element 17 (the center of top portion 18A of protrusion 18 or the center of base portion 18B of protrusion 18) that is the closest to said each protrusion-recess element 17 is less than 8 μm. In other words, since protrusions 18 are arranged in a lattice pattern, distance d between the centers of top portions 18A or between the centers of base portions 18B of protrusions 18 that are adjacent to each other in the X-direction or the Y-direction is less than 8 μm. The formation of such protrusion-recess elements 17 on inner surface 3A of second substrate 3 can efficiently limit the reflection of infrared rays of the wavelength band within the range of 8-14 μm, which is the band useful for infrared sensor 1.

Thus, protrusion-recess structure 16 has the same function as an antireflection film. However, forming an antireflection film on inner surface 3A of second substrate 3 that has large protrusions and recesses such as insulation film 13 is potentially difficult. As will be described later, protrusion-recess structure 16 can be easily formed on inner surface 3A of second substrate 3 that has large protrusions and recesses. On the other hand, outer surface 3B of second substrate 3 is substantially flat and is suitable for forming an antireflection film. For these reasons, antireflection film 20 is provided on outer surface 3B of second substrate 3. Accordingly, reflection of infrared rays can be limited both on inner surface 3A and on outer surface 3B of second substrate 3, and the ratio of infrared rays that are transmitted through second substrate 3 can be further increased. The entire outer surface 3B need not be made flat, but outer surface 3B may be flat at least in regions 14A (see FIG. 3) that are opposite element facing regions 14 in the Z-direction. It should be noted that a protrusion-recess structure that has the same arrangement as inner surface 3A may be formed on outer surface 3B of second substrate 3.

Antireflection film 20 may be formed, for example, of zinc sulfide, fermented yttrium, chalcogenide glass, germanium, silicon, zinc selenide, gallium arsenic, diamond-like carbon, or the like. Antireflection film 20 may be a stack of films in which films having different refraction indexes are sequentially arranged and the reflection ratio of infrared rays is reduced by intervention of waves that are reflected at each film. In this case, antireflection film 20 may be a stack of films that include, for example, an oxide film, a nitride film, a sulfide film, a fluoride film, a borosilicate film, a bromide film, a chloride film, a selenide film, a germanium film, a diamond film, a chalcogenide film, a silicon film, or the like, as well as films of the materials mentioned above.

Inner surface 3A has support protrusion 31 in boundary region 15. The shape of support protrusion 31 is not limited, but support protrusion 31 has, for example, a lattice pattern shape. Support portions 9 are supported by end surface 31A of support protrusion 31 via insulation film 13. As shown in FIG. 6, as seen in the Z-direction, diameter D1 of the largest circle C1 that can be arranged in end surface 31A of support protrusion 31 may be larger than diameter D2 of the largest circle C2 that can be arranged in top portion 18A of protrusion 18. In the present embodiment, because top portion 18A is a circle, the largest circle C2 matches top portion 18A. Alternatively, width W of boundary region 15 (the dimension of boundary region 15 in the direction that is perpendicular to the long-axis direction of boundary region 15) may be larger than distance d between the centers of top portions 18A of adjacent protrusions 18. For example, when distance d is 6 μm, width W of boundary region 15 may be larger than 6 μm. The width of insulation film 13 is larger than the widths (diameters) of first and second conductive pillars 10X and 10Y, and the width of boundary region 15 is larger than the width of insulation film 13 (the dimension of insulation film 13 in the direction that is perpendicular to the long-axis direction of insulation film 13). For this reason, insulation film 13 and first and second conductive pillars 10X and 10Y can be stably formed.

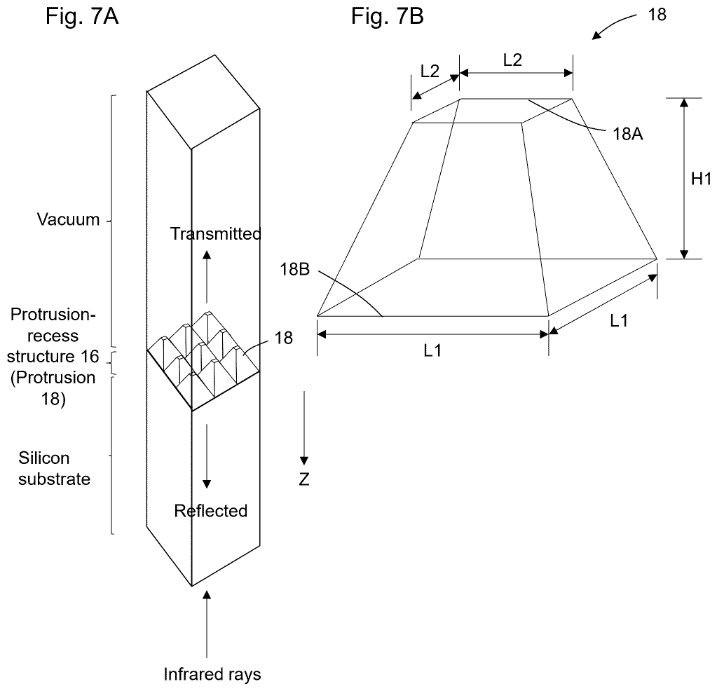

Next, the performance of limiting reflection was evaluated by a simulation for various shapes of protrusion-recess structure 16. FIG. 7A shows a model that was used in the simulation. The upper part of the quadrangular prism model simulates a vacuum, the lower part simulates the silicon substrate and the middle part simulates protrusion-recess structure 16. Protrusion-recess structure 16 is formed of 3×3, i.e., nine protrusions 18. Infrared rays were inputted onto the base of the model in the direction opposite to the Z-direction of the model. The infrared rays travelled in the silicon substrate in the direction opposite to the Z-direction, were partially absorbed by the silicon substrate, were partially reflected by protrusion-recess structure 16 and returned to the silicon substrate, and the rest were transmitted through protrusion-recess structure 16 to reach the vacuum space. Thus, the reflection ratio, the transmission ratio, and the absorption ratio of the infrared rays were obtained using the model. FIG. 7B shows the shape of protrusions 18. Here, each protrusion 18 is a truncated pyramid that has a rotational symmetry of order 4, square base portion 18B and square top portion 18A. Length L1 of base portion 18B was 2 μm; length L2 of top portion 18A was 0.2 μm, 0.4 μm, 0.6 μm, 0.8 μm and 1.0 μm; and height H1 of protrusion 18 was 0.5 μm, 1.0 μm, 1.5 μm, 2.0 μm, 3.5 μm, 5.0 μm, 6.5 μm and 8.0 μm. Wavelength λ of infrared rays was 8 μm, 9 μm, 10 μm, 11 μm, and 12 μm. As a comparative example, the same calculation was performed for a model that does not have protrusion-recess structure 16. Table 1 shows the reflection ratio, the transmission ratio, and the absorption ratio of infrared rays of the comparative example.

TABLE 1

| Wavelength | Transmission | Reflection | Absorption |
|---|---|---|---|
| (μm) | ratio (%) | ratio (%) | ratio (%) |
| 8 | 68.6 | 31.3 | 0.1 |
| 9 | 69.7 | 29.9 | 0.3 |
| 10 | 69.9 | 29.8 | 0.3 |
| 11 | 69.7 | 29.6 | 0.7 |
| 12 | 69.8 | 29.7 | 0.5 |

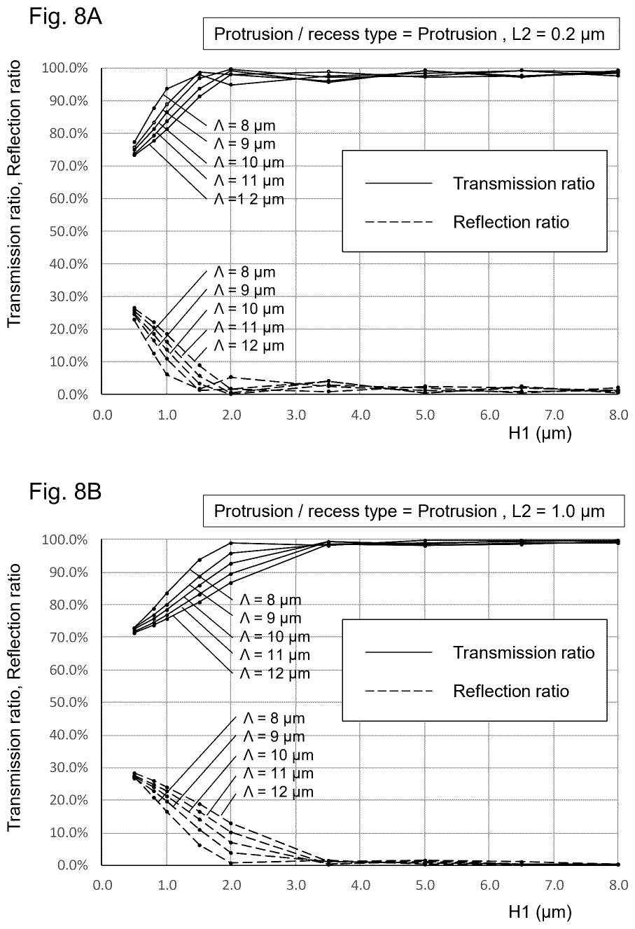

FIG. 8A shows the calculation results for L2=0.2 μm and FIG. 8B shows the calculation results for L2=1.0 μm. The absorption ratio was omitted because it was very small. The variations of the reflection ratio and the transmission ratio due to the differences in wavelength λ and the differences in length L2 of top portion 18A were small. Although not illustrated, calculation was performed for lengths L2 of top portion 18A=0.4 μm, 0.6 μm, and 0.8 μm, but no major difference was found in the transmission ratio and the reflection ratio as compared to L2=0.2 μm and L2=1.0 μm. The transmission ratio was slightly larger than the comparative example when height H1 of protrusion 18=0.5 μm, and still larger than the comparative example when height H1=1 μm, and still larger than the comparative example when height H1=1.5 μm. The height of protrusion-recess structure 16 (height H1 of protrusion 18) may be 0.5 μm or larger, 1.0 μm or larger, 1.5 μm or larger, or 2 μm or larger. When the height of protrusion-recess structure 16 is 2.0 μm or larger, the variations of the transmission ratio and the reflection ratio due to wavelength were small. It should be noted that the upper limit of height H1 of protrusion-recess structure 16 is not limited in view of increasing the transmission ratio.

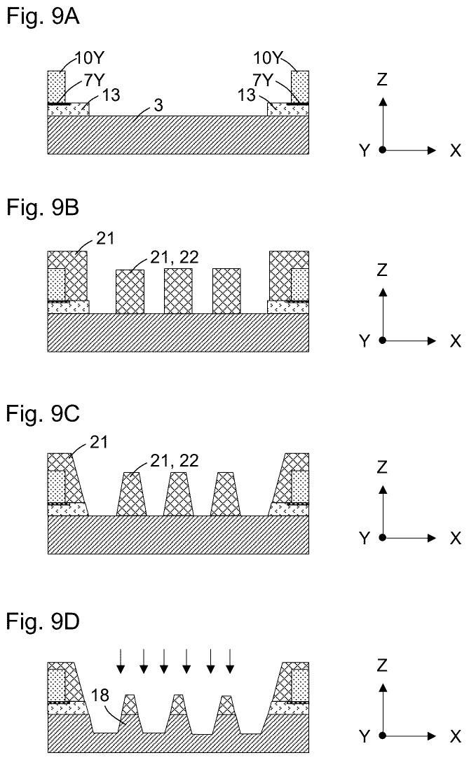

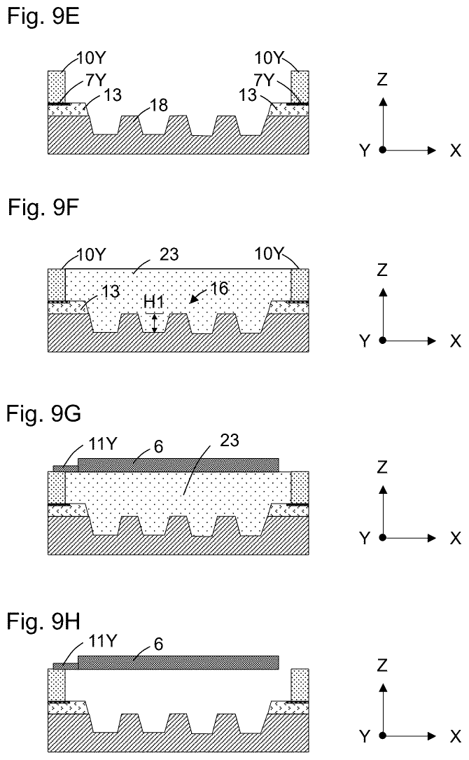

Next, a method of manufacturing infrared sensor 1 described above will be described focusing particularly on the steps for forming protrusion-recess structure 16. FIGS. 9A to 9H are sectional views that mainly show the steps for forming protrusion-recess structure 16. In FIGS. 9A to 9H, first wires 7X and first conductive pillars 10X are not illustrated. First, as shown in FIG. 9A, insulation film 13, first and second wires 7X and 7Y, and first and second conductive pillars 10X and 10Y are formed on second substrate 3. Next, as shown in FIG. 9B, second substrate 3, insulation film 13, first and second wires 7X and 7Y, and first and second conductive pillars 10X and 10Y are covered with photoresist 21, and cylindrical patterns 22 are formed by exposure and development.

Next, as shown in FIG. 9C, a baking process is performed for photoresist 21, and photoresist 21 is formed into a shape in which the thickness increases from the top toward the base. Next, as shown in FIG. 9D, an inductively coupled plasma reactive ion etching process (shown by the arrow) is performed using photoresist 21 as a mask. Thus, the part of second substrate 3 that is not covered with photoresist 21 is removed by etching, and the part of second substrate 3 that is covered with photoresist 21 becomes protrusions 18 having a truncated cone shape. Next, as shown in FIG. 9E, photoresist 21 is removed. Next, as shown in FIG. 9F, insulation film 13 and protrusion-recess structure 16 are covered with organic sacrifice layer 23 and the tops of first and second conductive pillars 10X and 10Y are exposed. Next, as shown in FIG. 9G, first and second conductive arms 11X and 11Y and electromagnetic wave detection elements 6 are formed on organic sacrifice layer 23. Next, as shown in FIG. 9H, organic sacrifice layer 23 is removed. Thereafter, although not illustrated, first substrate 2 and second substrate 3 are joined via side wall 4. In FIG. 9F, organic sacrifice layer 23 is formed so as to bury protrusion-recess structure 16. If height H1 of protrusions 18 is too high, forming organic sacrifice layer 23 up to the base of protrusion-recess structure 16 is difficult. Height H1 of protrusions 18 may be 8 μm or smaller.

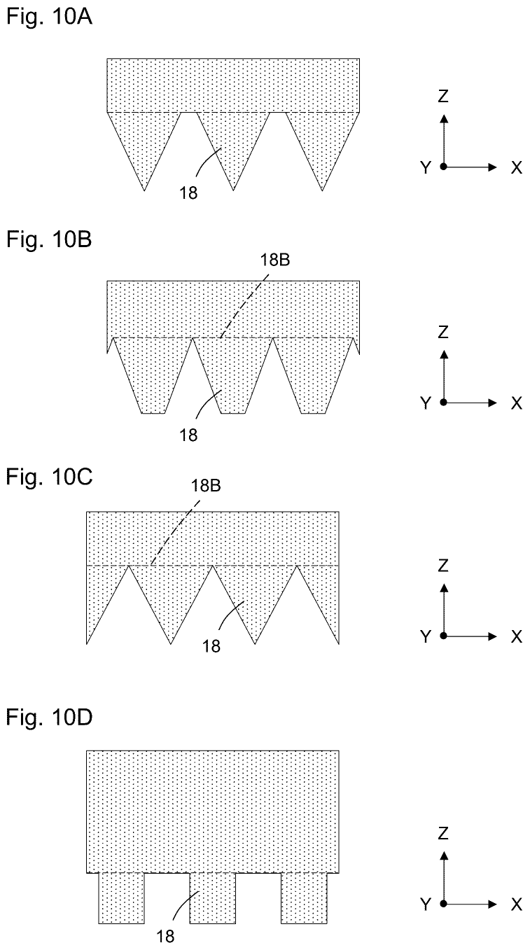

FIGS. 10A to 10D show modifications of protrusions 18. As shown in FIG. 10A, protrusions 18 may be cones. As shown in FIG. 10B, base portions 18B of adjacent protrusions 18 may be in contact with each other. As shown in FIG. 10C, protrusions 18 may be cones and base portions 18B of adjacent protrusions 18 may be in contact with each other. As shown in FIG. 10D, protrusions 18 may be cylinders. Although not illustrated, sides of the truncated cones or the cones may be bent outward or inward in FIG. 4 and FIGS. 10A to 10C.

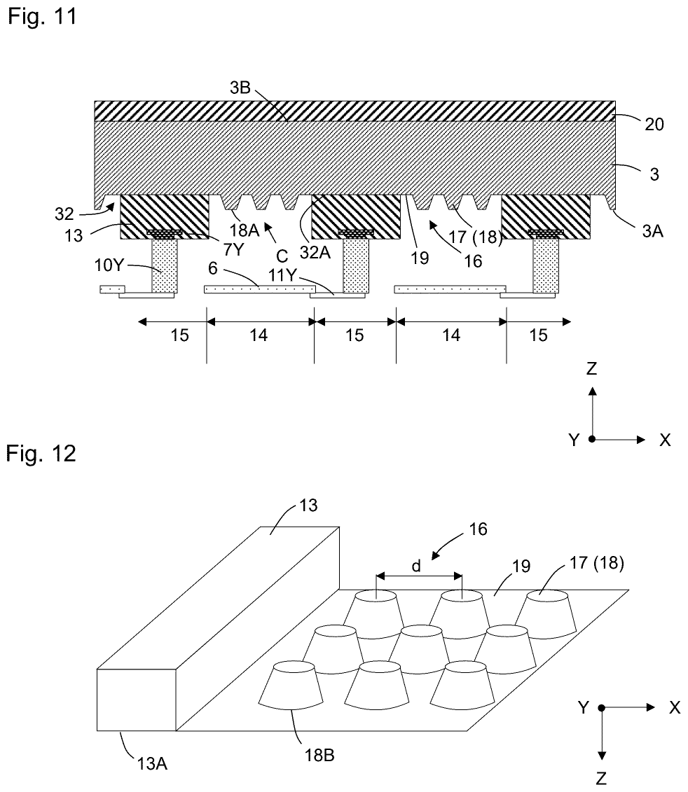

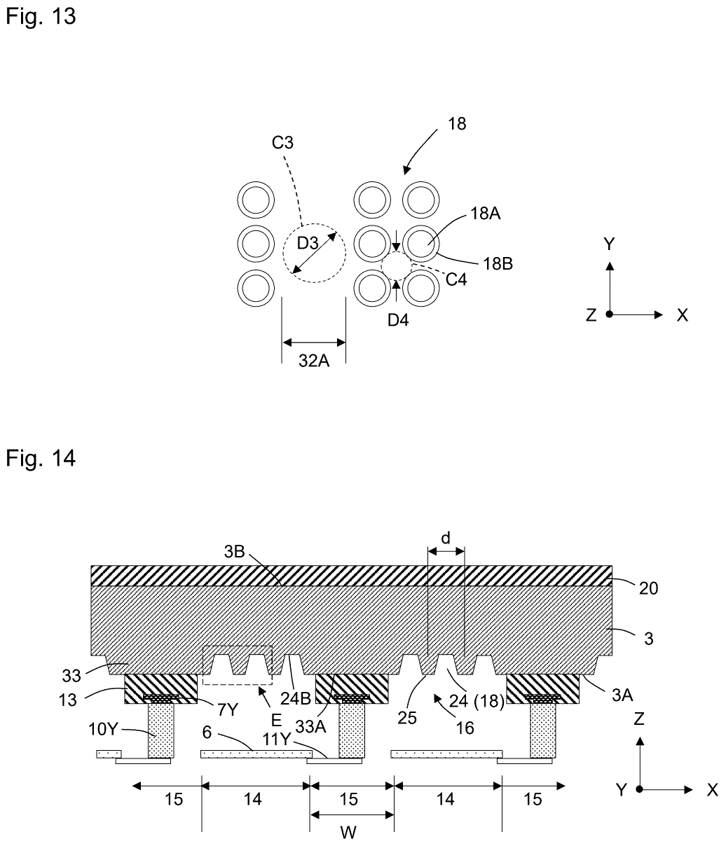

FIGS. 11 to 13 show a modification of second substrate 3. FIG. 11, FIG. 12, and FIG. 13 correspond to FIG. 3, FIG. 5, and FIG. 6, respectively. FIG. 11 is an enlarged view of part B in FIG. 1, FIG. 12 is a schematic perspective view of inner surface 3A of second substrate 3 that is shown in FIG. 11, and FIG. 13 is a schematic partial plan view of inner surface 3A of second substrate 3 that is shown in FIG. 11 as seen in the Z-direction. In this modification, inner surface 3A has, in boundary region 15, support recess 32 that is recessed from top portions 18A of protrusions 18, and support portions 9 are supported by base surface 32A of support recess 32 via insulation film 13. The shape of support recess 32 is not limited, but support recess 32 has, for example, a lattice pattern shape. Second substrate 3 is excavated at the position of insulation film 13, and thus, base portion 13A of insulation film 13 (boundary region 15) and base portions 18B of protrusions 18 are positioned at the same level in the Z-direction. Protrusions 18 have the same shape and arrangement as protrusions 18 of the first embodiment. As shown in FIG. 13, diameter D3 of the largest circle C3 that can be arranged in base surface 32A of support recess 32 as seen in the Z-direction may be larger than diameter D4 of the largest circle C4 that can be arranged between base portions 18B of protrusions 18 in element facing region 14.

### Second Embodiment

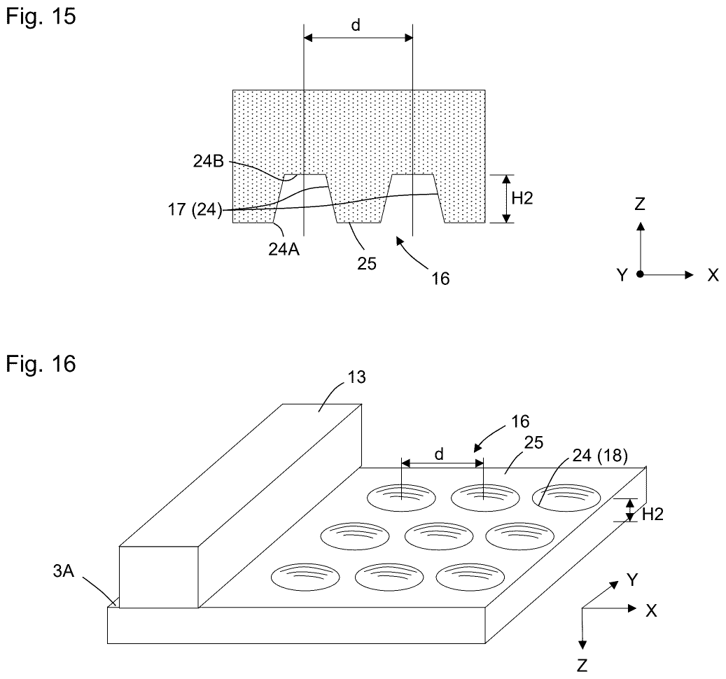

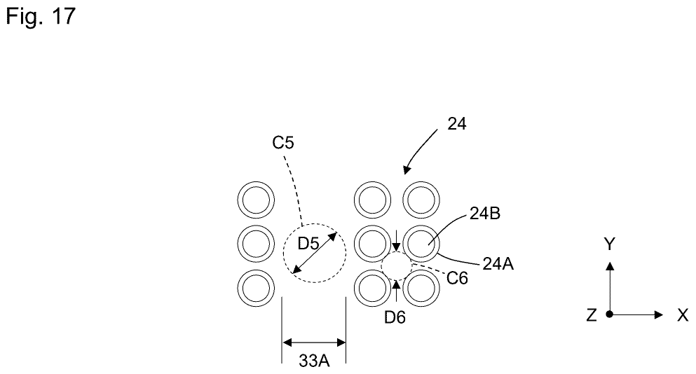

The present embodiment is the same as the first embodiment with the exception that protrusion-recess elements 17 that form protrusion-recess structure 16 are recesses 24. Description of arrangements and effects that are the same as the first embodiment is here omitted. FIGS. 14-17 correspond to FIGS. 3-6, respectively. FIG. 14 is an enlarged view of part B in FIG. 1, FIG. 15 is an enlarged view of part E in FIG. 14, FIG. 16 is a schematic perspective view of inner surface 3A of second substrate 3, and FIG. 17 is a schematic partial plan view of inner surface 3A of second substrate 3 as seen in the Z-direction. Recess 24 has a substantially complementary shape to protrusion 18 of the first embodiment. Recess 24 is substantially a truncated cone in which the area of opening 24A that faces first substrate 2 is larger than the area of base surface 24B. Openings 24A of recesses 24 are positioned at the same level as inner surface 3A of second substrate 3 in the Z-direction. As seen in the Z-direction, recesses 24 are arranged substantially in a lattice pattern, but alternatively may be arranged in a staggered pattern, may be arranged partially in a lattice pattern or a staggered pattern, or may be arranged in a totally random pattern. Flat region 25 is provided between adjacent recesses 24.

When recesses 24 are provided, the refraction index of a protrusion-recess structure that is smaller than the wavelength of infrared rays is also sensed as an average value of the refraction indexes of two mediums that form the protrusion-recess structure (in this case, silicon and a vacuum). A large change in the refraction index is therefore limited at the boundary, and reflection is consequently limited. In addition, for example, when recess 24is a truncated cone as shown in FIG. 15, the ratio of the area of silicon and the area of vacuum in an X-Y section gradually changes in the Z-direction. Accordingly, the refraction index of protrusion-recess structure 16 continuously changes in the Z-direction and reflection is further limited. Also in the present embodiment, as seen in the Z-direction, distance d between the center of each protrusion-recess element 17 (the center of opening 24A of recess 24 or the center of base surface 24B of recess 24) and the center of another protrusion-recess element 17 that is the closest to said each protrusion-recess element 17 (the center of opening 24A of recess 24 or the center of base surface 24B of recess 24) is less than 8 μm. In other words, because recesses 24 are arranged in a lattice pattern, distance d between the centers of openings 24A or between the centers of base surfaces 24B of recesses 24 that are adjacent to each other in the X-direction or the Y-direction is less than 8 μm. Width W of boundary region 15 may be larger than the distance between openings 24A of adjacent recesses 24. In the present embodiment, inner surface 3A includes in boundary region 15 support protrusion 33 that protrudes from base surfaces 24B of recesses 24, and support portions 9 are supported by end surface 33A of support protrusion 33 via insulation film 13. The shape of support protrusion 33 is not limited, but support protrusion 33 has, for example, a lattice pattern shape. As shown in FIG. 17, as seen in the Z-direction, diameter D5 of the largest circle C5 that can be arranged in end surface 33A of support protrusion 33 may be larger than diameter D6 of the largest circle C6 that can be arranged between openings 24A of recesses 24 in the element facing region 14.

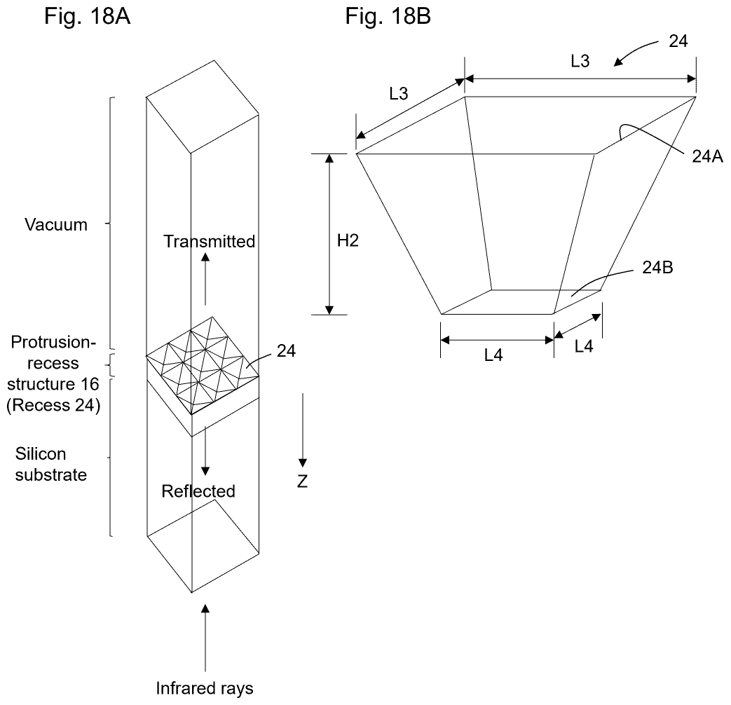

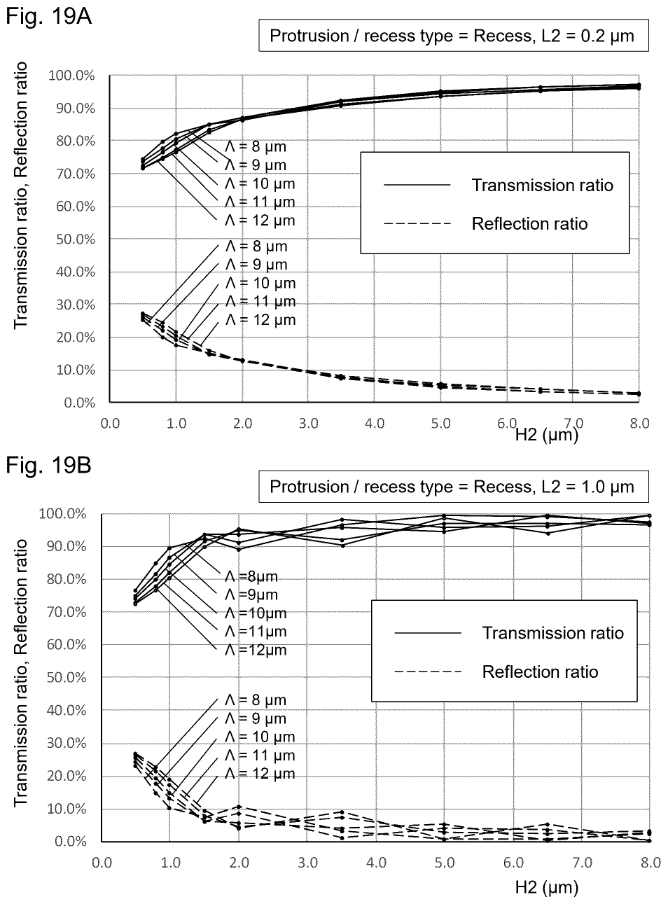

Next, the performance of limiting reflection was evaluated by a simulation for protrusion-recess structures 16 that have recesses 24 of various shapes. FIG. 18A shows the model that was used in the simulation. The upper part of the quadrangular prism model simulates a vacuum, the lower part simulates the silicon substrate, and the middle part simulates the protrusion-recess structure 16. Protrusion-recess structure 16 is formed of 3×3, i.e., nine recesses 24. In the same manner as the previously-described simulation, infrared rays were inputted onto the base of the model in the direction opposite to the Z-direction of the model, and the reflection ratio, the transmission ratio, and the absorption ratio of the infrared rays were obtained. FIG. 18B shows the shape of recesses 24. Each recess 24 is a truncated pyramid that has square opening 24A and square base surface 24B. Length L3 of opening 24A was 2 μm; length L4 of base surface 24B was 0.2 μm, 0.4 μm, 0.6 μm, 0.8 μm and 1.0 μm; and height H2 of recess 24 was 0.5 μm, 1.0 μm, 1.5 μm, 2.0 μm, 3.5 μm, 5.0 μm, 6.5 μm and 8.0 μm.

FIG. 19A shows the calculation results for L4=0.2 μm, and FIG. 19B shows the calculation results for L4=1.0 μm. The absorption ratio was omitted because it was very small. The variations of the reflection ratio and the transmission ratio due to the differences in wavelength A and the differences in length L4 of base surface 24B were small. Although not illustrated, calculation was performed for length L4 of base surface 24B=0.4 μm, 0.6 μm and 0.8 μm, but no major difference was found in the transmission ratio and the reflection ratio. The transmission ratio was slightly larger than the comparative example when height H2 of recess 24=0.5 μm, still larger than the comparative example when height H2=1 μm, and still larger than the comparative example when height H2=1.5 μm. The height of protrusion-recess structure 16 (height H2 of recess 24) may be 0.5 μm or larger, 1.0 μm or larger, 1.5 μm or larger, or 2 μm or larger. When the height of protrusion-recess structure 16 is 1.5 μm or larger, the variations of the transmission ratio and the reflection ratio due to wavelength were small. It should be noted that the upper limit of height H2 of protrusion-recess structure 16 is not limited in view of increasing the transmission ratio.

Protrusion-recess structure 16 may be formed in the same manner as the first embodiment. In the present embodiment, a pattern having cylindrical cavities is formed in FIG. 9B. Next, in the same manner as in FIG. 9C, a baking process is performed for photoresist 21, and photoresist 21 is formed into a shape in which the diameter of the cavity decreases from the opening toward the base. Next, as shown in FIG. 9D, an inductively coupled plasma reactive ion etching process is performed using photoresist 21 as a mask. Thus, the part of second substrate 3 that is not covered with photoresist 21 is removed by etching, and recesses 24 having truncated cone shapes are formed. The subsequent processes are performed in the same manner as in the first embodiment. If height H2 of recess 24 is too high, forming organic sacrifice layer 23 up the base of protrusion-recess structure 16 is difficult. Height H2 of recess 24 may be 8 μm or smaller.

Modifications of recesses 24 may be made in the same manner as in the first embodiment. For convenience, the region between protrusions 18 in FIGS. 10A to 10D is regarded as recess 24 in the present embodiment. As shown in FIG. 10A, openings 24A of adjacent recesses 24 may be in contact with each other. As shown in FIG. 10B, recesses 24 may be cones. As shown in FIG. 10C, openings 24A of adjacent recesses 24 may be in contact with each other and recesses 24 may be cones. As shown in FIG. 10D, recesses 24 may be cylinders. Although not illustrated, sides of the truncated cones or the cones may be bent outward or inward in FIG. 15 and FIGS. 10A to 10C.

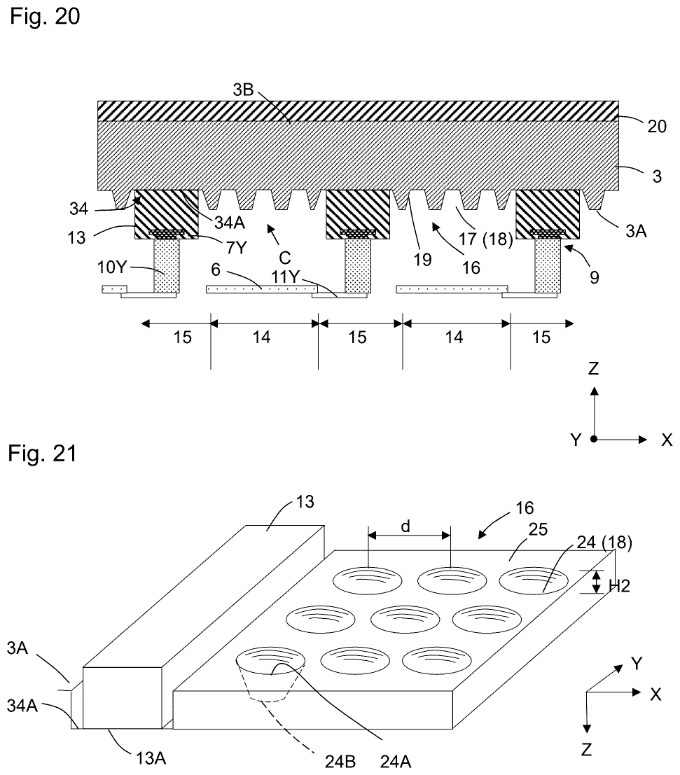

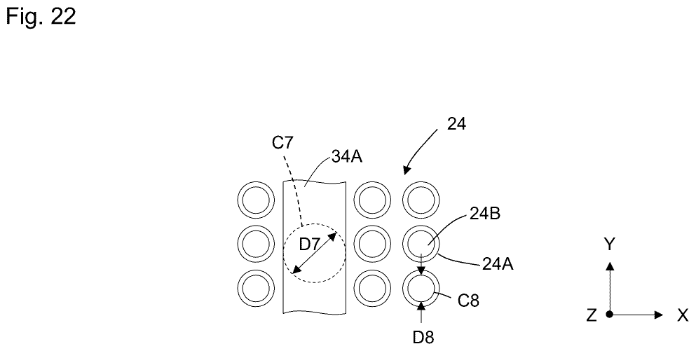

FIGS. 20 to 22 show a modification of second substrate 3. FIG. 20, FIG. 21, and FIG. 22 correspond to FIG. 3, FIG. 5, and FIG. 6, respectively. FIG. 20 is an enlarged view of part B in FIG. 1, FIG. 21 is a schematic perspective view of inner surface 3A of second substrate 3, and FIG. 22 is a schematic partial plan view of inner surface 3A of second substrate 3. In this modification, inner surface 3A has support recess 34 in boundary region 15. The shape of support recess 34 is not limited, but support recess 34 has, for example, a lattice pattern shape. Support portions 9 are supported by base surface 34A of support recess 34 via insulation film 13. Second substrate 3 is excavated at the position of insulation film 13, and thus, base portion 13A of insulation film 13 and base surfaces 24B of recesses 24 are positioned at the same level in the Z-direction. Recesses 24 have the same shape and arrangement as in the second embodiment. As shown in FIG. 22, diameter D7 of the largest circle C7 that can be arranged in base surface 34A of support recess 34 as seen in the Z-direction may be larger than diameter D8 of the largest circle C8 that can be arranged in base surface 24B of recess 24. In the present embodiment, because base surface 24B is a circle, the largest circle C8 matches base surface 24B.

Although certain embodiments of the present disclosure have been shown and described in detail, it should be understood that various changes and modifications may be made without departing from the spirit or scope of the appended claims.

### LIST OF REFERENCE NUMERALS

1 Infrared sensor (electromagnetic wave sensor)
2 First substrate
3 Second substrate
3A Inner surface
3B Outer surface
5 Inner space
6 Electromagnetic wave detection element
7X, 7Y First and second wires
9 Support portion
13 Insulation film
14 Element facing region
15 Boundary region
16 Protrusion-recess structure
17 Protrusion-recess element
18 Protrusion
20 Antireflection film
24 Recess
31, 33 Support protrusion
32, 34 Support recess

1. An electromagnetic wave sensor comprising:
a first substrate;
a second substrate that faces the first substrate, that forms an inner space between the first substrate and the second substrate, and that transmits electromagnetic waves; and
electromagnetic wave detection elements that are provided in the inner space, wherein
the second substrate has an inner surface that faces the first substrate,
the inner surface has element facing regions that face the electromagnetic wave detection elements,
the element facing regions include a protrusion-recess structure, and
the protrusion-recess structure has protrusion-recess elements that are formed of recesses or protrusions, and as seen in a direction in which the first substrate and the second substrate face each other, a distance between a center of a protrusion-recess element and a center of another protrusion-recess element that is closest to the protrusion-recess element is less than 8 μm.

2. The electromagnetic wave sensor according to claim 1,
wherein the second substrate has an outer surface that is a back surface of the inner surface,
further comprising an antireflection film that is provided on the outer surface.

3. The electromagnetic wave sensor according to claim 2, wherein regions of the outer surface that are opposite the element facing regions in the direction are flat.

4. The electromagnetic wave sensor according to claim 1, further comprising support portions that support the respective electromagnetic wave detection elements, wherein
the inner surface has a boundary region that is positioned between the element facing regions, and
the support portions are supported by the boundary region.

5. The electromagnetic wave sensor according to claim 4, further comprising an insulation film that is provided between the support portions and the second substrate in the boundary region.

6. The electromagnetic wave sensor according to claim 5, further comprising wires that are supported by the insulation film and that are electrically connected to the respective electromagnetic wave detection elements.

7. The electromagnetic wave sensor according to claim 4, wherein
the protrusion-recess elements are protrusions,
the inner surface has a support protrusion in the boundary region,
the support portions are supported by an end surface of the support protrusion, and
as seen in the direction, a diameter of a largest circle that can be arranged in the end surface of the support protrusion is larger than a diameter of a largest circle that can be arranged in a top portion of each of the protrusions.

8. The electromagnetic wave sensor according to claim 4, wherein
the protrusion-recess elements are protrusions,
the inner surface has, in the boundary region, a support recess that is recessed from top portions of the protrusions,
the support portions are supported by a base surface of the support recess, and
as seen in the direction, a diameter of a largest circle that can be arranged in the base surface of the support recess is larger than a diameter of a largest circle that can be arranged between base portions of the protrusions in the element facing region.

9. The electromagnetic wave sensor according to claim 4, wherein
the protrusion-recess elements are recesses,
the inner surface has, in the boundary region, a support protrusion that protrudes from base surfaces of the recesses,
the support portion is supported by an end surface of the support protrusion, and
as seen in the direction, a diameter of a largest circle that can be in an end surface of the support protrusion is larger than a diameter of a largest circle that can be arranged between openings of the recesses in the element facing region.

10. The electromagnetic wave sensor according to claim 4, wherein
the protrusion-recess elements are recesses,
the inner surface has a support recess in the boundary region,
the support portion is supported by a base surface of the support recess, and
as seen in the direction, a diameter of a largest circle that can be arranged in the base surface of the support recess is larger than a diameter of a largest circle that can be arranged in a base surface of each of the recesses.

11. The electromagnetic wave sensor according to claim 1, wherein a height of the protrusion-recess structure is 1 μm or larger.
